(19) United States
(12) Patent Application Publication
(10) Pub. No.: US 2026/0151839 A1
(43) Pub. Date: Jun. 4, 2026

(54) A ROCK-CUTTING APPARATUS FOR DIAMOND WIRE ROCK-CUTTING, AND A METHOD FOR BLIND-CUTTING ROCK

(71) Applicant: FRAVIZEL - EQUIPAMENTOS METALOMECÂNICOS, S.A., Alcanede (PT)

(72) Inventor: Eliseu Manuel VICENTE FRAZÃO, Alcanede (PT)

(21) Appl. No.: 19/122,742

(22) PCT Filed: Oct. 18, 2023
(86) PCT No.: PCT/IB2023/060504

§ 371 Date: Apr. 20, 2025

(30) Foreign Application Priority Data
Oct. 20, 2022 (PT) 118272

(51) Int. Cl. B23D 57/00; B23D 61/18; B28D 1/12; B28D 5/00

(52) U.S. Cl. CPC B23D 61/185; B28D 1/08

(57) ABSTRACT

The present disclosure is enclosed in the area of rock extraction, in particular the processing of cutting stone masses in quarries to provide the guiding of a diamond wire, including blind rock cutting. It is an object of the present disclosure a rock-cutting apparatus for diamond wire rock-cutting. Through the provision of free rotating edge pulleys rotatably coupled to the edges of arms, when a diamond wire is provided, such rotation allows that, at the edge the arm, the direction of the portion of the diamond wire passing through such edge pulley also changes. Such arrangement provides an enhanced blind cutting, which does not involve the destruction of a mass of rock.

### FIELD OF THE DISCLOSURE

The present disclosure is enclosed in the area of rock extraction, in particular the processing of cutting stone masses in quarries to provide the guiding of a diamond wire, including blind rock cutting.

### PRIOR ART

There are places where the exploration of ornamental rock requires exploring in depth, in a particular level at a specific depth.

The method which is still the most frequently used in the exploration of ornamental rock to open a new lower level consists of the opening by explosives or hydraulic hammer, resulting in the destruction of the raw material therein.

Prior art solutions also include processes in which three types of equipment are used: pulleys, poles and cutting machine. Such processes require too many cables and equipment on a bench, as well as several operators for its execution. This is a lengthy process and of crucial importance since a first cut (individualizing a rock mass) will have an influence on the quality of the blocks. Also, where this type of exploration is carried out, the use of saw machines doesn't have an economically viable application.

The present solution innovatively overcomes such issues.

### SUMMARY OF THE DISCLOSURE

It is an object of the present disclosure a rock-cutting apparatus for diamond wire rock-cutting. The apparatus may comprise:
two parallel and spaced apart arms, each of the arms being suitable to be provided in a substantially perpendicular manner to the ground, when in a cutting position, and each arm being movable along a direction which is parallel to the arm itself,
two edge pulleys, each being suitable to run a diamond wire and each being rotatably coupled to one of said arms in an edge of each corresponding arm, and
tensioning means, the tensioning means being configured to, when one diamond wire is provided through the tensioning means, through the two edge pulleys and thereby along the arms and again back to the tensioning means, thus forming a closed loop, provide a tension in such diamond wire such that the wire, when in motion, is able to cut rock,
   wherein the two edge pulleys are arranged such that a closed-loop diamond wire is directly providable between the two edge pulleys, forming a cutting section between the two edge pulleys, and such that, when in motion, the cutting section of the diamond wire is able to cut rock,
   wherein each of the edge pulleys is further freely rotatable along an axis which is parallel to the respective arm, such that portions of the cutting section of the diamond wire running through each edge pulley follow the direction of the respective edge pulley, and wherein the edge pulleys are provided at the extremity of the arm, such that no other element is provided after, the diamond wire, when provided forming a closed loop, thereby running at the extremity of the arm.

The apparatus may further comprise a diamond wire provided through the tensioning means, through the two edge pulleys and thereby along the arms and again back to the tensioning means, thus forming a closed loop.

The apparatus may further comprise control means, the control means being configured to actuate and thereby move a diamond wire providable through the tensioning means, through the two edge pulleys and thereby along the arms and again back to the tensioning means, thus forming a closed loop and thereby being able to cut rock in the cutting section formed between the two edge pulleys.

Each of the arms may have an extension such that each of the respective edge pulleys may be provided, when cutting rock, down to a depth of 0.5-40 m, optionally 0.5-35 m, optionally 0.5-30 m, optionally 0.5-25 m, optionally 0.5-20 m, optionally 0.5-15 m, optionally 0.5-10 m, optionally 0.5-5 m, optionally 5-40 m, optionally 10-40 m, optionally 15-40 m, optionally 20-40 m, optionally 25-40 m, optionally 30-40 m, optionally 35-40 m, optionally 0.5 m, optionally 5 m, optionally 10 m, optionally 15 m, optionally 20 m, optionally 25 m, optionally 30 m, optionally 35 m, optionally 40 m.

The arms may be extendable, thereby each arm being movable along a direction which is parallel to the arm itself. The arms may be extendable through pneumatic, hydraulic or electric extension means.

The apparatus may further comprise forward translation moving means, the forward translation moving means being configured to move at least the arms and the respective edge pulleys along a direction which is:
perpendicular to the arms,
when in a cutting position, substantially parallel to a ground plane, and
such that when the forward translation moving means move the arms and edge pulleys, does not change the distance between the two arms and, thus, also does not change the distance between the two respective edge pulleys.

The ground plane may be provided horizontally, vertically or in another orientation (e.g., transversally).

The apparatus may further comprise lateral translation moving means, the lateral translation moving means being configured to move at least the arms and the respective edge pulleys along a direction which is:
perpendicular to the arms,
when in a cutting position, substantially parallel to a ground plane, and
such that when the lateral translation moving means move the arms and edge pulleys, changes the distance between the two arms and, thus, also changes the distance between the two respective edge pulleys.

The apparatus may further comprise two stabilization pulleys, each of the two stabilization pulleys being:
suitable to run a diamond wire,
coupled to a respective arm,
provided adjacently to a respective edge pulley and, thus, above the edge of the respective arm,
   such that it stabilizes a diamond wire passing through the respective edge pulley.

Each of the arms may be hollow, forming a hollow column wherein, when a diamond wire is provided through the tensioning means, through the two edge pulleys and thereby along the arms and again back to the tensioning means, the diamond wire runs inside the hollow column.

The apparatus may further comprise a rotation element, the rotation element being coupled to an edge of the arm and being such that the diamond wire is able to run through it, the rotation element being provided between said edge of the arm and a corresponding edge pulley, such that it provides for the free rotation of such edge pulley and the rotation element is provided between said edge of the arm and a corresponding stabilization pulley, the rotation element also thus providing for the free rotation of the ensemble formed by the stabilization pulley and the corresponding edge pulley.

It is also an object of the present disclosure a method for blind-cutting rock with a diamond wire to obtain a mass of rock substantially forming a parallelepiped. The method may comprise the steps of:
i) cutting a first straight section of the rock, the first straight section being substantially perpendicular to a ground plane, and down to a predefined depth,
ii) cutting a second straight section of the rock, the second straight section being parallel to and having the same extension as the first straight section, and down to the predefined depth,
iii) cutting a third straight section of the rock, the third straight section being substantially perpendicular to the same ground plane, being perpendicular to the first and second straight sections, and connecting two edges of the first and second straight sections which are closer to one another, and down to the predefined depth,
iv) starting from an edge position of the third straight section at the predefined depth, cutting the rock along a plane substantially parallel to the ground plane and formed by the first, second and third sections at the predefined depth, until a line which connects two edges of the first and second straight sections which are closer to one another, at the predefined depth, is reached,
v) from the position of the line reached in step iv) cutting a fourth straight section of the rock, the fourth straight section being parallel to the third straight section, thereby being perpendicular to the first and second straight sections, and connecting two edges of the first and second straight sections which are closer to one another, until the ground plane is reached,
   thereby obtaining the mass of rock substantially forming a parallelepiped.

The method may comprise, prior to cutting each of the first, second and third straight sections, the mass of rock is drilled, forming a first hole with a direction substantially perpendicular to the ground plane, and a second hole, which is parallel to the first hole, both holes being formed down to the predefined depth, the straights section thereby being formed by cutting the mass the rock perpendicularly to the ground plane along the respective first and second holes.

The method may comprise that each of said holes has a diameter of 80-300 mm, optionally of 100-250 mm.

The method may be implemented by the apparatus of the present disclosure.

### DESCRIPTION OF FIGURES

FIG. 1—representation of an apparatus according to the present disclosure. The apparatus may comprise two arms (2), which may form hollow columns, through which a diamond wire (5) runs through. At edges of each arm (2), edge pulleys (9) are provided. Tensioning means (not shown as a whole) are provided and tension the diamond wire (5) which runs inside the arms (2) and through both edge pulleys (9). The section of the diamond wire (5) which is momentarily between the two edge pulleys (9) forms a cutting section. The term momentarily is used, since the diamond wire (5) is in constant movement to provide cutting and, therefore, a portion of the wire (5) which is between the two edge pulleys (9) is continuously changing. The diamond wire (5) thereby forms a closed loop. The apparatus is represented while cutting a vertical (substantially perpendicular to a ground plane) section in a mass of rock (4). Previously, holes (3) have been formed. The arms (2) and respective edge pulleys (9) are provided along the holes (3).

FIG. 2—detailed representation of the apparatus of FIG. 1. Control means (11) (not entirely shown) are provided, causing the actuation and thereby movement of the diamond wire (5) through tensioning means, through the two edge pulleys (9) and thereby along the arms (2) and again back to the tensioning means, thus forming a closed loop. An additional upper pulley (10) provided in an edge of an arm (2) which is opposite to the edge of the edge pulley (9), may be provided. Although FIG. 2 refers to a single arm, to each of the arms (2) may be associated an upper pulley (10).

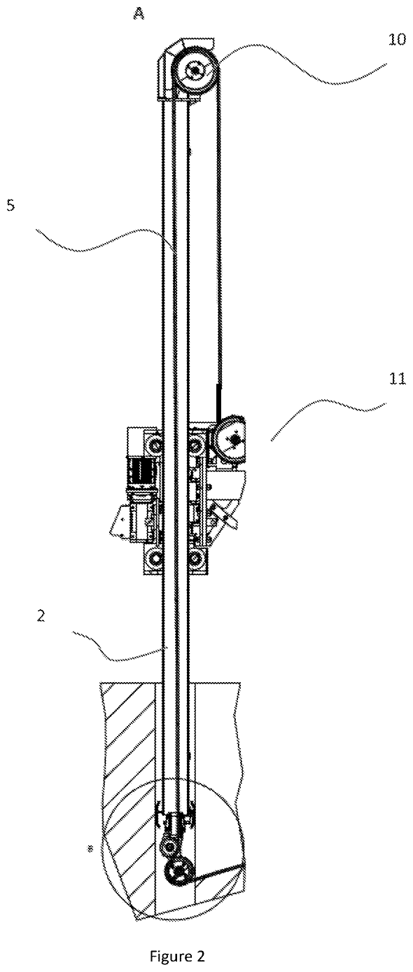

FIG. 3—-detailed representation of the apparatus of FIGS. 1 and 2. The diamond wire (5) runs through an edge pulley (9), which is provided at the edge of the respective arm (2). The diamond wire (5) also runs through a stabilization pulley (8), which is also coupled to a respective arm (2) and adjacently to the respective edge pulley (2). The stabilization pulley (8) stabilizes a diamond wire (5) passing through the respective edge pulley (9), by being adjacently provided. Supports (6) are also provided, supporting of the arm (2) along the hole (3). The stabilization pulley (8) rotates jointly with the edge pulley (9). A rotation element (7) provides for the free rotation of the ensemble formed by the edge pulley (9) and stabilization pulley (8). The diamond wire (5) runs through the rotation element (7). The rotation element (7) is provided at the edge of the arm (2). Although FIG. 3 refers to a single arm, to each of the arms (2) are associated these elements, described in respect of FIG. 3.

### DETAILED DESCRIPTION

Several configurations of the objects of the present disclosure are described in the Summary of the disclosure. Such configurations are further described below.

The two arms are parallel and spaced apart. The cutting section is thus formed between the two edge pulleys and, therefore, it substantially has the extension of the space provided between the spaced apart and parallel arms.

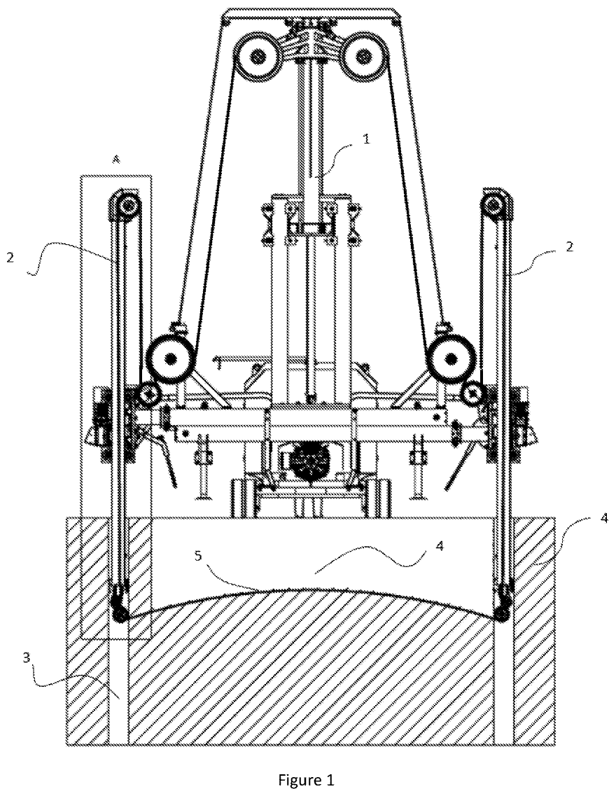

When in a cutting position, each of the arms is provided in a substantially perpendicular manner to a ground plane. Thus, and as shown in FIG. 1, the apparatus provides for a cutting of a rock section along holes. When a diamond wire is provided. The arms may thus move along a direction which is parallel to the arm itself, thus moving the edge pulley and the wire along the hole and cutting the said section.

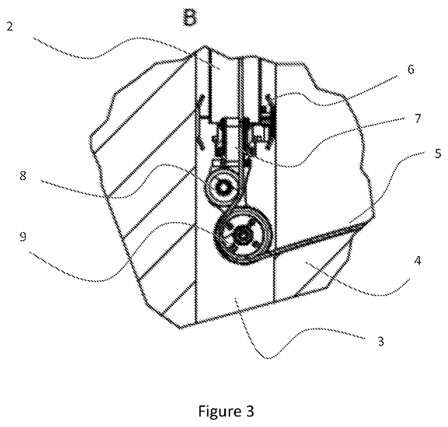

The edge pulleys are provided at the extremity of the arm, such that no other element is provided after. the diamond wire, when provided forming a closed loop, thereby runs at the extremity of the arm, as shown in FIG. 3.

When a stabilization pulley is provided, the stabilization pulley is between the edge pulley and the edge of the arm. Such arrangement provides that, of course, the diamond wire runs through the edge pulley and, when a stabilization pulley is provided, also along the stabilization pulley (which is adjacent to the edge pulley, being between the edge pulley and the arm).

Each of the edge pulleys is rotatably coupled to an arm. Such rotation of the edge pulleys is free. When a stabilization pulley is provided, the stabilization pulley also freely rotates, as it rotates jointly with the edge pulley.

The tensioning means are such that provide the tensioning of the diamond wire. The diamond wire runs through the two edge pulleys and, when stabilization pulleys are provided, also through the respective stabilization pulleys. The diamond wire is thus in tension and forms a closed loop, such that—when in motion—is able to cut rock. The circuit of the diamond wire may be described as leaving the tensioning means, going through an edge pulley, then through another edge pulley, and back to the tensioning means, forming a closed loop. Between each edge pulley and the tensioning means, the diamond wire runs along (or, when forming a hollow column, within), the arms.

The free rotation of the edge pulleys is along an axis which is parallel to the respective arm. FIG. 3 present an example of such rotation, through the rotation element. Such rotation element is provided in the continuation of the arm and allows both the edge pulley and the stabilization pulley to rotate. The respective axles of each the edge pulley and the stabilization pulley, which provide the running of the diamond wire, thus also rotate.

Thus, portions of the cutting section of the diamond wire running through each edge pulley follow the direction of the respective edge pulley (and stabilization pulley, if provided).

The rotation of the edge pulley thus provides that, at the edge of the arm, the direction of the portion of the diamond wire passing through such edge pulley also changes. Such arrangement provides an enhanced blind cutting, which does not involve the destruction of a mass of rock.

It further enables that, after three sections of rock are cut, all being substantially perpendicular to the ground panel and substantially forming an “U” (when in top view), a section of rock which is parallel to the ground panel is blindly cut.

In addition, it thereby consists of an enhanced implementation of the method of the present disclosure.

A mass of rock is drilled, forming a first hole with a direction substantially perpendicular to the ground plane, and a second hole, which is parallel to the first hole, both holes being formed down to the predefined depth, the straights section thereby being formed by cutting the mass the rock perpendicularly to the ground plane along the respective first and second holes.

Then, each of the arms of the apparatus of the present disclosure is provided in one of the holes. Then, a first straight section of the rock is cut with the diamond wire—through the cutting section—, the first straight section being substantially perpendicular to a ground plane, and down to a predefined depth.

Then, two more additional holes as above described are drilled, such that each of the arms of the apparatus may be provided in one of such additional holes and a second straight section of the rock may be cut, the second straight section being parallel to and having the same extension as the first straight section, and down to the predefined depth.

Then, each of the arms of the apparatus may be provided in one of the previously formed holes, such that a third straight section of the rock may be cut—through the cutting section—, the third straight section being substantially perpendicular to the same ground plane, being perpendicular to the first and second straight sections, and connecting two edges of the first and second straight sections which are closer to one another, and down to the predefined depth.

From such edge position of the third straight section at the predefined depth, the apparatus—through the cutting section—provides the cutting the rock along a plane substantially parallel to the ground plane and formed by the first, second and third sections at the predefined depth, until a line which connects two edges of the first and second straight sections which are closer to one another, at the predefined depth, is reached.

From the position of the said reached line, the apparatus provides the cutting a fourth straight section of the rock—through the cutting section—, the fourth straight section being parallel to the third straight section, thereby being perpendicular to the first and second straight sections, and connecting two edges of the first and second straight sections which are closer to one another, until the ground plane is reached.

The apparatus thereby provides an enhanced blind cut of a mass of rock substantially forming a parallelepiped.

The apparatus may further comprise control means, the control means being configured to actuate and thereby move a diamond wire providable through the tensioning means, through the two edge pulleys and thereby along the arms and again back to the tensioning means, thus forming a closed loop and thereby being able to cut rock in the cutting section formed between the two edge pulleys.

Each of the arms may have an extension such that each of the respective edge pulleys may be provided, when cutting rock, down to a depth of 0.5-40 m, optionally 0.5-35 m, optionally 0.5-30 m, optionally 0.5-25 m, optionally 0.5-20 m, optionally 0.5-15 m, optionally 0.5-10 m, optionally 0.5-5 m, optionally 5-40 m, optionally 10-40 m, optionally 15-40 m, optionally 20-40 m, optionally 25-40 m, optionally 30-40 m, optionally 35-40 m, optionally 0.5 m, optionally 5 m, optionally 10 m, optionally 15 m, optionally 20 m, optionally 25 m, optionally 30 m, optionally 35 m, optionally 40 m. Such is the depth reached by the edge pulleys, or the diamond wire which may run through the edge pulleys. The arms themselves may have higher extensions.

The apparatus may further comprise forward translation moving means, the forward translation moving means being configured to move at least the arms and the respective edge pulleys along a direction which is:
perpendicular to the arms,
when in a cutting position, substantially parallel to a ground plane, and
such that when the forward translation moving means move the arms and edge pulleys, does not change the distance between the two arms and, thus, also does not change the distance between the two respective edge pulleys.

The forward translation moving means thus allow that the ensemble formed by the arms and edge pulleys (and stabilization pulleys, if provided) is movable along the said direction. Such therefore allows that a section of rock along a plane which is perpendicular to the arms (e.g. parallel to the ground plane) is cut.

The apparatus may further comprise lateral translation moving means, the lateral translation moving means being configured to move at least the arms and the respective edge pulleys along a direction which is:
perpendicular to the arms,
when in a cutting position, substantially parallel to a ground plane, and
such that when the lateral translation moving means move the arms and edge pulleys, changes the distance between the two arms and, thus, also changes the distance between the two respective edge pulleys.

The lateral translation moving means thus allow that the ensemble formed by the arms and edge pulleys (and stabilization pulleys, if provided) is movable along the said direction. Such therefore allows that the cutting section is widened or narrowed, thereby enabling that wider or narrower straight sections of rock are cut.

The apparatus may further comprise two stabilization pulleys, each of the two stabilization pulleys being:
suitable to run a diamond wire,
rotatably coupled to a respective arm,
provided adjacently to a respective edge pulley and thus rotating jointly with the respective edge pulley, thus,
   such that it stabilizes a diamond wire passing through the respective edge pulley.

The stabilization pulleys, which have been previously described, allow for the stabilization of the diamond wire. Such stabilization is obtained through the said adjacent provision. Also, it is enhanced when the relative arrangement of the stabilization pulley and a respective edge pulley is such that it imposes an inflexion of the diamond wire provided between such stabilization pulley and edge pulley, when a diamond wire is provided forming a closed loop. Such inflexion may be described in a way that the stabilization pulley is between the edge pulley and the edge of the arm and, when a diamond wire is provided forming a closed loop, each stabilization pulleys is arranged such that the wire runs along a stabilization pulley in a direction opposite to the direction in which the wire runs along the respective edge pulley. The inflexion is presented in FIG. 3.

Each of the arms may be hollow, forming a hollow column wherein, when a diamond wire is provided through the tensioning means, through the two edge pulleys and thereby along the arms and again back to the tensioning means, the diamond wire runs inside the hollow column.

The method may comprise, prior to cutting each of the first, second and third straight sections, the mass of rock is drilled, forming a first hole with a direction substantially perpendicular to the ground plane, and a second hole, which is parallel to the first hole, both holes being formed down to the predefined depth, the straights section thereby being formed by cutting the mass the rock perpendicularly to the ground plane along the respective first and second holes.

The method may comprise that each of said holes has a diameter of 80-300 mm, optionally of 100-250 mm.

As will be clear to one skilled in the art, the present disclosure should not be limited to the embodiments described herein, and a number of changes are possible which remain within the scope of the present disclosure.

Of course, the preferred embodiments shown above are combinable, in the different possible forms, being herein avoided the repetition all such combinations.

1. A rock-cutting apparatus for diamond wire rock-cutting comprising:
two parallel and spaced apart arms, each of the arms being suitable to be provided in a substantially perpendicular manner to the ground, when in a cutting position, and each arm being movable along a direction which is parallel to the arm itself,
two edge pulleys, each being suitable to run a diamond wire and each being rotatably coupled to one of said arms in an edge of each corresponding arm, and
tensioning means, the tensioning means being configured to, when one diamond wire is provided through the tensioning means, through the two edge pulleys and thereby along the arms and again back to the tensioning means, thus forming a closed loop, provide a tension in such diamond wire such that the wire, when in motion, is able to cut rock,
wherein the two edge pulleys are arranged such that a closed-loop diamond wire is directly providable between the two edge pulleys, forming a cutting section between the two edge pulleys, and such that, when in motion, the cutting section of the diamond wire is able to cut rock,
wherein each of the edge pulleys is further freely rotatable along an axis which is parallel to the respective arm, such that portions of the cutting section of the diamond wire running through each edge pulley follow the direction of the respective edge pulley,
and wherein the edge pulleys are provided at the extremity of the arm, such that no other element is provided after, the diamond wire, when provided forming a closed loop, thereby running at the extremity of the arm.

2. An apparatus according to claim 1 further comprising two stabilization pulleys, each of the two stabilization pulleys being:
suitable to run a diamond wire,
rotatably coupled to a respective arm,
provided adjacently to a respective edge pulley and thus rotating jointly with the respective edge pulley, thus,
such that the apparatus stabilizes a diamond wire passing through the respective edge pulley.

3. An apparatus according to claim 2 wherein the relative arrangement of a stabilization pulley and a respective edge pulley is set to imposes an inflexion of the diamond wire between such stabilization pulley and edge pulley, when a diamond wire is provided forming a closed loop.

4. An apparatus according to claim 3 further comprising a diamond wire provided through the tensioning means, through the two edge pulleys and thereby along the arms and again back to the tensioning means, thus forming a closed loop.

5. An apparatus according to claim 1 further comprising control means, the control means being configured to actuate and thereby move a diamond wire providable through the tensioning means, through the two edge pulleys and thereby along the arms and again back to the tensioning means, thus forming a closed loop and thereby being able to cut rock in the cutting section formed between the two edge pulleys.

6. An apparatus according to claim 1 wherein each of the arms has an extension such that each of the respective edge pulleys may be provided, when cutting rock, down to a depth of 0.5-40 m, optionally 0.5-35 m, optionally 0.5-30 m, optionally 0.5-25 m, optionally 0.5-20 m, optionally 0.5-15 m, optionally 0.5-10 m, optionally 0.5-5 m, optionally 5-40 m, optionally 10-40 m, optionally 15-40 m, optionally 20-40 m, optionally 25-40 m, optionally 30-40 m, optionally 35-40 m, optionally 0.5 m, optionally 5 m, optionally 10 m, optionally 15 m, optionally 20 m, optionally 25 m, optionally 30 m, optionally 35 m, optionally 40 m.

7. An apparatus according to claim 1 wherein the arms are extendable, thereby each arm being movable along a direction which is parallel to the arm itself.

8. An apparatus according to claim 7 wherein the arms are extendable through pneumatic or hydraulic extension means.

9. An apparatus according to claim 1 further comprising forward translation moving means, the forward translation moving means being configured to move at least the arms and the respective edge pulleys along a direction which is:
perpendicular to the arms,
when in a cutting position, substantially parallel to a ground plane, and
such that when the forward translation moving means move the arms and edge pulleys, does not change the distance between the two arms and, thus, also does not change the distance between the two respective edge pulleys.

10. A apparatus according to claim 1 further comprising lateral translation moving means, the lateral translation moving means being configured to move at least the arms and the respective edge pulleys along a direction which is:
perpendicular to the arms,
when in a cutting position, substantially parallel to a ground plane, and
such that when the lateral translation moving means move the arms and edge pulleys, changes the distance between the two arms and, thus, also changes the distance between the two respective edge pulleys.

11. An apparatus according to claim 1 wherein each of the arms is hollow, forming a hollow column wherein, when a diamond wire is provided through the tensioning means, through the two edge pulleys and thereby along the arms and again back to the tensioning means, the diamond wire runs inside the hollow column.

12. An apparatus according to claim 1 further comprising a rotation element, the rotation element being coupled to an edge of the arm and being such that the diamond wire is able to run through such rotation element, the rotation element being provided between said edge of the arm and a corresponding edge pulley, such that the rotation element provides for the free rotation of such edge pulley and the rotation element is provided between said edge of the arm and a corresponding stabilization pulley, the rotation element also thus providing for the free rotation of the ensemble formed by the stabilization pulley and the corresponding edge pulley.

13. A method for blind-cutting rock with a diamond wire to obtain a mass of rock substantially forming a parallelepiped, the method comprising the steps of:
i) cutting a first straight section of the rock, the first straight section being substantially perpendicular to a ground plane, and down to a predefined depth,
ii) cutting a second straight section of the rock, the second straight section being parallel to and having the same extension as the first straight section, and down to the predefined depth,
iii) cutting a third straight section of the rock, the third straight section being substantially perpendicular to the same ground plane, being perpendicular to the first and second straight sections, and connecting two edges of the first and second straight sections which are closer to one another, and down to the predefined depth,
iv) starting from an edge position of the third straight section at the predefined depth, cutting the rock along a plane substantially parallel to the ground plane and formed by the first, second and third sections at the predefined depth, until a line which connects two edges of the first and second straight sections which are closer to one another, at the predefined depth, is reached,
v) from the position of the line reached in step iv) cutting a fourth straight section of the rock, the fourth straight section being parallel to the third straight section, thereby being perpendicular to the first and second straight sections, and connecting two edges of the first and second straight sections which are closer to one another, until the ground plane is reached,
thereby obtaining the mass of rock substantially forming a parallelepiped,
wherein the method is implemented by
a rock-cutting apparatus for diamond wire rock-cutting which comprises:
two parallel and spaced apart arms, each of the arms being suitable to be provided in a substantially perpendicular manner to the ground, when in a cutting position, and each arm being movable along a direction which is parallel to the arm itself,
two edge pulleys, each being suitable to run a diamond wire and each being rotatably coupled to one of said arms in an edge of each corresponding arm, and
tensioning means, the tensioning means being configured to, when one diamond wire is provided through the tensioning means, through the two edge pulleys and thereby along the arms and again back to the tensioning means, thus forming a closed loop, provide a tension in such diamond wire such that the wire, when in motion, is able to cut rock,
wherein the two edge pulleys are arranged such that a closed-loop diamond wire is directly providable between the two edge pulleys, forming a cutting section between the two edge pulleys, and such that, when in motion, the cutting section of the diamond wire is able to cut rock,
wherein each of the edge pulleys is further freely rotatable along an axis which is parallel to the respective arm, such that portions of the cutting section of the diamond wire running through each edge pulley follow the direction of the respective edge pulley,
and wherein the edge pulleys are provided at the extremity of the arm, such that no other element is provided after, the diamond wire, when provided forming a closed loop, thereby running at the extremity of the arm.

14. A method according to claim 13 wherein, prior to cutting each of the first, second and third straight sections, the mass of rock is drilled, forming a first hole with a direction substantially perpendicular to the ground plane, and a second hole, which is parallel to the first hole, both holes being formed down to the predefined depth, the straights section thereby being formed by cutting the mass the rock perpendicularly to the ground plane along the respective first and second holes.

15. A method according to claim 14 wherein each of said holes has a diameter of 80-300 mm, optionally of 100-250 mm.
